(19) United States
(12) Patent Application Publication
(10) Pub. No.: US 2015/0040462 A1
(43) Pub. Date: Feb. 12, 2015

(54) FISHING ROD RETAINER

(71) Applicant: RODNEY TJEERDSMA, OMAHA, NE (US)

(72) Inventor: RODNEY TJEERDSMA, OMAHA, NE (US)

(21) Appl. No.: 14/457,538

(22) Filed: Aug. 12, 2014

Related U.S. Application Data
(60) Provisional application No. 61/864,927, filed on Aug. 12, 2013.

(51) Int. Cl. A01K 97/10; A01K 87/02

(52) U.S. Cl. CPC A01K 97/10; A01K 87/02
USPC 43/18.1 CT; 43/21.2

(57) ABSTRACT

A fishing rod retainer is disclosed, the retainer having a retainer body with one or more surfaces forming a perimeter. At least two openings are disposed within the surface and extending into the retainer, each opening forming a channel. A line retention groove extends at least partially along the surface, the retention groove configured to receive a portion of fishing line when the retainer is in use.

### CROSS-REFERENCE TO RELATED APPLICATIONS

This application claims priority pursuant to 35 U.S.C. 119(e) to co-pending U.S. Provisional Patent Application Ser. No. 61/864,927, filed Aug. 12, 2013, the entire disclosures of which are incorporated herein by reference.

### BACKGROUND

Many fishing rods comprise an elongated member having a handle at one end, a tip at the opposing end and one or more eyes mounted to the elongated member. The eyes function to provide a path for fishing line that is spooled on a reel and terminates at a lure, swivel, hook, or other device. To have suitable characteristics for strength, flexibility, or other parameters, fishing rods may be designed to be rather long. Such rods are difficult to transport and may be easily damaged when they are placed in vehicles.

Accordingly, many rods have a multi-piece (most commonly a two-piece) construction in which a junction is provided along the lateral member between the handle and the tip. The junction is often a simple slip fitting in which a first portion of the rod (having the handle and a junction portion distal to the handle) is provided with a female fitting and a second portion of the rod (having the tip and a junction portion distal to the tip) is provided with a male fitting or visa-versa. The male fitting may simply be a continuous extension of the rod portion.

When transporting an assembled rod with tackle attached to the line, the tackle may be coupled to the rod at a position near the handle by a loop or eye. This allows tension to be applied to the line by the reel to keep the lure retained and prevent a slack line from becoming entangled with other objects. Unfortunately, the length of assembled rods make it difficult to transport them any significant distance in this configuration without causing damage to the lure, reel, or pole. Consequently, many two piece poles are disassembled for transport. This, however, allows for the line to be slack which leads to tangling, lost tackle, and other problems. Accordingly, when multi part poles are disassembled, the tackle is often removed from the line and the tag end of the line secured to a position on or near the reel. When a destination is reached, the line must be threaded through the eyes and the tackle reattached.

Accordingly, there is a need for a device to allow transportation and/or storage of a two-piece rod without the need of removing tackle located at the end of the fishing line.

### SUMMARY

Some embodiments relate to a fishing rod retainer having a retainer body with one or more surfaces forming a perimeter. At least two openings are disposed within the surface and extending into the retainer, each opening forming a channel. A line retention groove extends at least partially along the surface, the retention groove configured to receive a portion of fishing line when the retainer is in use.

### BRIEF DESCRIPTION OF THE DRAWINGS

FIG. 1 is a top, front perspective view of a multi-piece fishing rod retainer.

FIG. 2 is a top, side perspective view of the fishing rod retainer of FIG. 1.

FIG. 3 is a bottom, front perspective view of the fishing rod retainer of FIG. 1.

FIG. 4 is a top, front relief review of the fishing rod retainer of FIG. 1.

FIG. 5 is a top, side perspective view of a fishing rod clip for use with the fishing rod retainer of FIG. 1.

FIG. 6 is a top, side perspective view of the fishing rod clip of FIG. 5.

### DETAILED DESCRIPTION

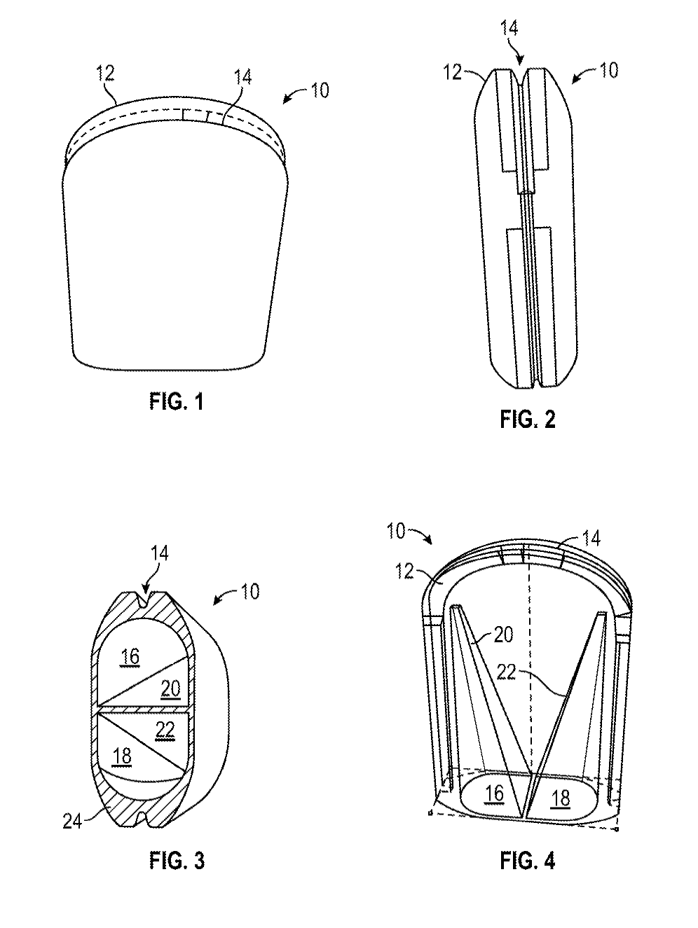

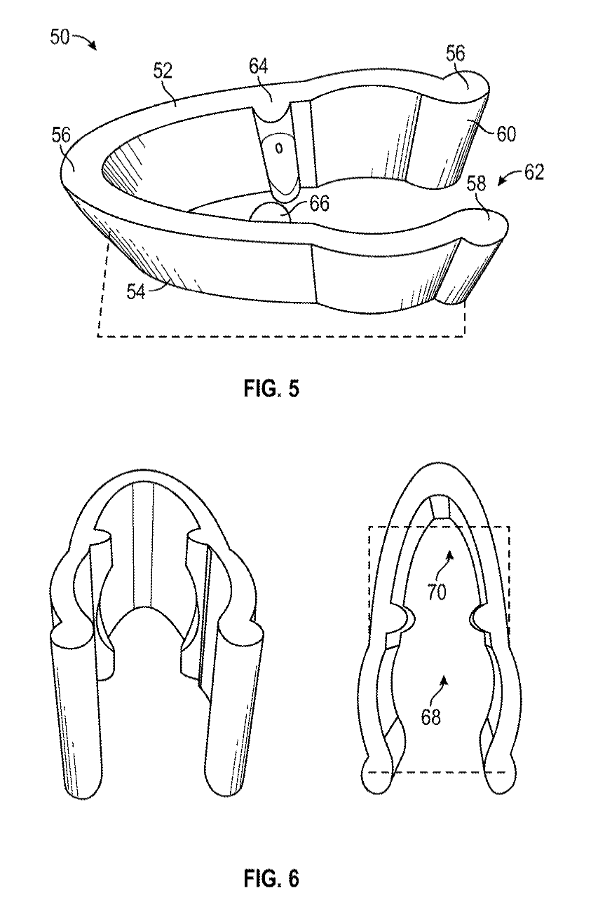

Referring to FIGS. 1-4, a two-piece rod may be secured in its disassembled configuration in such a way that the line is not slack and the tackle is secured. This is accomplished by use of a retainer. The retainer 10 may be generally characterized as having a rectangular shape with an arcuate end 12. In some embodiments, the geometry may be that of a rectangle having a semi-circle at one side. Along the outside for three sides of the retainer is a groove 14 configured to at least partially receive fishing line of various diameters. A pair of openings 16 and 18 may be provided in a flat end 4 opposite the arcuate end 12 and having channels extending into the retainer 10 generally parallel to a major axis of the retainer.

The interior surfaces of the channels may be configured in one of several ways to facilitate a friction fit with the ends of rod segments. Because the female junction will be of greater outside diameter than the male junction, a pair of matching, constant inside diameter channels would not, in and of themselves be effective.

To accommodate a variety of rod diameters, the interior surface of the channels may be tapered continuously (as in a conical or truncated cone shape) or stepwise (i.e., with a series of cylindrical segments of reduced diameter). In some embodiments, the stepwise segments may be tapered themselves. In the embodiment shown, the channels include an angled sides 20 and 22 configured to constrict the circumference of the channels as they extend inwardly from end 24.

In some embodiments, an oversized channel may be provided in which a retention device is provided. Some retention devices may comprise a foam insert that may resiliently deform with the insertion of a rod segment while providing sufficient friction to retain the rod segment. Alternatively, one or more resilient members and/or spring loaded arms may be provided that are biased towards the center of the channel. These members and/or arms may be deformed or displaced by a rod segment and provide sufficient friction to retain the rod segment in the channel.

To increase the versatility of a single retainer, more than two channels may be provided such that a wider variety of rod segment diameters may be accommodated that would be possible with only two such channels. In some embodiments, parallel pairs of opening may be provided along the perimeter of a disk. The disk may have a second arcuate structure positioned on a side of the disk, the second arcuate structure having a groove for receiving the fishing line. Alternatively, a groove may be provided about the perimeter of the disk. While a round disk could be used, a polygonal disc such as a triangle, rectangle, pentagon, hexagon, etc. may also be suitable. When polygonal shapes are used, the corner may be rounded to reduce localized stress on the fishing line. In the case of a retainer having multiple sets of openings, they may all be configured similarly to the various embodiments disclosed herein (i.e., having foam inserts, tapered configurations, biased arms etc.

The retainer itself may be formed of any suitable material and may be designed to be particularly suitable for various manufacturing processes. These may include variations of plastic molding and other methods of manufacture.

Referring to FIGS. 5 and 6, a retaining clip 50 is shown. Clip 50 may be used in concert with the fishing rod retainer of FIGS. 1-4. In use, clip 50 may be used to secure the tip end of the second segment of the fishing pole to the handle end of the first segment of the fishing pole. Clip 50 includes arms 52 and 54 that join at junction 56. As shown the arms and junction are formed as a single, unitary body.

Arms 52 and 54 include ends 56 and 58, respectively, positioned distal to junction 56. Ends 56 and 58 are shown as generally rounded such that surfaces 60 and 62 are provided which may be used to guide a fishing rod into the clip. Additional protrusions 64 and 66 may also be provided interiorly to the clip to divide the opening defined by the clip into two portions: first portion 68 and second portion 70. In use, ends 56 and 58 are spaced apart a distance of less than the diameter of the portion of the rod to be retained in first portion 68, and protrusions 64 and 66 are spaced apart by a distance of less than the diameter of a portion of the rod to be retained in second portion 70. This configuration provides that the clip may snap over two fishing rod portions of different diameters. In general, clip 50 may be made of a material of sufficient resiliency to allow it to be repeatedly attached to and removed from a fishing rod.

Optionally a rod tip cover may be provided which may be used to further secure the disassembled rod. When disassembled and configured with the retainer, the rod tip will be positioned near the handle. The tip cover may include a body portion configured to slide over the rod tip and last eye to protect the tip and eye from damage. On one side of the cover, curved pads may be provided that are configured to partially mate with the rod handle and retain the rod tip cover relative thereto. One or more slots may also be provided on or near a portion of the body opposite the pads. The slots may receive one or more straps that may include hook-and-loop type fastening fabric for securing the tip end of the rod to the handle. This reduces the overall freedom of the rod tip and handle to move relative to each other and thereby reduces the risk of damage during transport.

In some embodiments the rod retainer may be about 10 cm long, 7 cm wide and 2.5 cm thick. Such a configuration would be advantageous for retaining rod segments of a variety of diameters. The rod tip cover may be about 10 cm long and have a diameter sufficient to receive a variety of rod ends. By way of example, the rod tip cover may have an inner diameter of about 3.5 cm with an outer diameter of about 5.5 cm to provide sufficient spacing between the rod segments.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description herein is for the purpose of describing particular embodiments only and is not intended to be limiting of the invention. As used in the description of the embodiments and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.” Many changes, modifications, variations, and other uses and applications of the present construction will, however, become apparent to those skilled in the art after considering the specification and the accompanying drawings. All such changes, modifications, variations, and other uses and applications which do not depart from the spirit and scope of the invention are deemed to be covered by the invention which is limited only by the claims which follow.

The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A fishing rod retainer comprising;
a retainer body having one or more surfaces forming a perimeter;
at least two openings disposed within the surface and extending into the retainer, each opening forming a channel; and
a line retention groove extending at least partially along the surface, the retention groove configured to receive a portion of fishing line when the retainer is in use.

2. The fishing rod retainer of claim 1, wherein the channels are tapered.

3. The fishing rod retainer of claim 1, wherein at least a portion of the retainer body perimeter is arcuate.

4. A kit having parts configured to facilitate the storage of a disassembled fishing rod, the kit comprising:
a fishing rod retainer having:
a retainer body having one or more surfaces forming a perimeter;
at least two openings disposed within the surface and extending into the retainer, each opening forming a channel;
a line retention groove extending at least partially along the surface, the retention groove configured to receive a portion of fishing line when the retainer is in use; and
a clip having a first arm and a second arm joined at a junction, each of the first and second arms including an interiorly oriented protrusion to define a plurality of regions for accepting fishing rod segments if different diameters.

5. The fishing rod retainer of claim 4, wherein the channels are tapered.

6. The fishing rod retainer of claim 4, wherein at least a portion of the retainer body perimeter is arcuate.

7. A fishing rod configured to be stored in an area of limited dimensions, the fishing rod comprising:
a first fishing rod segment having a handle at one end;
a second fishing rod segment having a tip at one end, the second fishing rod segment configured to be coupled to the first fishing rod segment to provide a single extended rod;
a fishing rod retainer comprising;
a retainer body having one or more surfaces forming a perimeter;
at least two openings disposed within the surface and extending into the retainer, each opening forming a channel, each channel configured to receive a portion of one of the first or second fishing rod segments distal to the handle or the tip; and
a line retention groove extending at least partially along the surface, the retention groove configured to receive a portion of fishing line when the retainer is in use.

8. The fishing rod of claim 7, further comprising a clip having a first arm and a second arm joined at a junction, each of the first and second arms including an interiorly oriented protrusion to define a plurality of regions for accepting fishing rod segments if different diameters.

9. The fishing rod of claim 7, wherein the channels of the retainer are tapered.

10. The fishing rod of claim 7, wherein at least a portion of the retainer body perimeter is arcuate.
